(19) United States
(12) Patent Application Publication
(10) Pub. No.: US 2023/0359450 A1
(43) Pub. Date: Nov. 9, 2023

(54) CLOUD APPLICATION ENGINE DEPLOYMENT METHOD FOR SHIELDING WEB FRAMEWORK FROM USERS AND APPARATUS, DEVICE AND STORAGE MEDIUM THEREOF

(71) Applicant: Nanjing Xiyin Ecommerce Co., Ltd., Nanjing (CN)

(72) Inventors: Xin LIANG, Nanjing (CN); Qing YANG, Nanjing (CN); Youlei ZHANG, Nanjing (CN)

(21) Appl. No.: 18/161,630

(22) Filed: Jan. 30, 2023

(30) Foreign Application Priority Data
May 9, 2022 (CN) 202210503287.4

(51) Int. Cl. G06F 8/61; G06F 9/54

(52) U.S. Cl. CPC G06F 8/63; G06F 9/547

(57) ABSTRACT

A cloud application engine deployment method for shielding the Web framework from users and apparatus, device and storage medium thereof, the method which includes: executing, by a docker, an initialization script and downloading, by the docker, an operating environment file to a first location; downloading, by the initialization script, a public framework script and a user script from the first location; specifying, by the initialization script, a second location; downloading the operating environment file to the second location; executing, by the operating environment file, the public framework script; loading, by the public framework script, the user script; registering the user script as a global handler; calling, by a caller, a Web interface; finding, by the caller, a corresponding handler, executing, by the caller, a code of the user script; and returning, from the caller, a result from the code of the user script.

### CROSS-REFERENCE TO RELATED APPLICATIONS

The present application claims priority to Chinese Patent Application No. 202210503287.4 filed on May 9, 2022, the contents of which is incorporated by reference herein in its entirety.

### TECHNICAL FIELD

The present invention relates to the deployment field of cloud application engine, in particular, to a cloud application engine deployment method for shielding the Web framework from users and apparatus, device and storage medium thereof.

### BACKGROUND

Most of applications using cloud application engine deployments need to provide external Web interfaces for service. Taking Python as an example, most use cases requires that the users write the code that provides Web interfaces by introducing Web frameworks (such as Flask™) But this usage has following disadvantages: (1) Users may not understand the HTTP (hypertext transfer protocol) protocol and Web frameworks. One example is where the user is an engineer doing algorithm development and only writes code for machine learning. In order for this code to be able to provide services to external consumers, he has to learn about Web frameworks or seek support from engineers who know service development. (2) When using Web frameworks, it is necessary to use various additional configurations to achieve tuning and customization of performance, compatibility, logging, and indicator reporting etc. For example, Python's Flask framework needs to introduce gunicorn (Green Unicorn), a multi-worker service framework, to enhance concurrency. This customization requires professional knowledge, which is difficult for non-professional back-end developers to master. (3) The Web protocol itself may change. For example, it might be necessary to modify the original HTTP REST (representational state transfer) protocol to the gRPC (gRPC remote procedure calls) protocol. At this time, a major modification to user code is required, which not only requires professional skills but also is labor-consuming and time-costing and requires a lot of testing.

With the development of Docker™ technology, the serverless technology has gradually become mature from general concept. The main principle is to shield the underlying technical details such as images, containers, and clusters, so that users can only care about their own business codes and leave functions, such as deployment, monitoring, and dynamic capacity expansion & reduction etc., to cloud service vendors to achieve free operation and maintenance, and on-demand use and payment. At the bottom layer, the code uploaded by the users will be typed into an image and then can be deployed to a container machine in the cloud. When using the product, users just need to write code that normally runs locally, without requiring any knowledge of Docker technology.

In order to solve the question of shielding the Web interface from users during the deployment of the cloud application engine, it is a feasible technical idea to try to use Docker technology. But new problems will still arise. The conventional idea of using the Docker technology is to put the operating environment into the image and making each operating environment into small isolated docker images. However, an operating environment based on application language is complex and changeable, and, in actual production practice, users of the platform have different working backgrounds and the operating environment will also vary greatly. The existing image can't meet the actual demand, which is especially prone to having the compatibility problem of environment migration. Currently, users can only make docker images by themselves, while making docker images requires Docker technology knowledge and other relevant professional knowledge, which creates new problems, such as: (1) The professional knowledge of Docker technology can't be shielded, and also the professional knowledge of Docker technology is equal to the professional knowledge of Web technology which also can't be shielded. This problem not only raises the threshold required to use the platform, but also spoils the experience of using the platform; (2) The docker images created by non-professional users can't be guaranteed, as are Web services written by non-professional users.

### SUMMARY

One of the purposes of this application is to provide a cloud application engine deployment method for shielding the Web framework from users and apparatus, devices, and storage mediums thereof. The application aims to shield Web frameworks and Docker knowledge for application developers and reduce implementation complexity and cost.

A cloud application engine deployment method for shielding the Web framework from users, comprising following steps: a docker starting to execute an initialization script and downloading an operating environment file to a specified location of the docker; the initialization script downloading a public framework script and a user script from the specified location; the operating environment file downloaded to local which is specified by the initialization script executing the public framework script, and the public framework script loading the user script and then being registered as a global handler; a caller calling a Web interface, and finding a corresponding handler and executing a code of the user script, and returning a result from the code of the user script.

In some embodiments, the operating environment file is a software and resource of an application instance in Python language; the operating environment file of the Python language comprises a base language library and an extension library. In some embodiments, the Python language uses a Conda package management tool, and its operating environment file is a Conda subdirectory.

In some embodiments, the public framework script comprises a script which contains Web framework and loaded user data, and the user script comprises user code and data.

In some embodiments, before the docker starts to execute an initialization script, a debugged operating environment file, a public framework script, and a user script are uploaded to a shared storage and an uploaded address on the docker is configured.

In some embodiments, before the docker starts to execute an initialization script, a docker image of the docker is a standard Linux image without an operating environment file of Python language.

In some embodiments, the shared storage is a distributed storage system.

In order to achieve the invention purpose of the above method, the present invention also provides a cloud application engine deployment apparatus that shields the Web framework from users, comprising: a module for downloading an operating environment file, the module being configured for a docker to execute an initialization script and download an operating environment file to a specified location of the docker; a module for downloading a public framework script, the module being configured for the initialization script to download a public framework script from the specified location; a module for downloading a user script, the module configured for the initialization script to download a user script from the specified location; an execution module configured for the operating environment file downloaded to local which is specified by the initialization script to execute the public framework script and for the public framework script to load the user script and then to be registered as a global handler; and a calling module configured for a caller to call a Web interface, find a corresponding handler, execute a code of the user script, and return a result.

The present invention also provides an electronic device, comprising a processor and a memory storing a computer program; the computer program, when executed by the processor, causing the processor to perform the operations of the above cloud application engine deployment method.

The present invention also provides a computer-readable storage medium, the computer-readable storage medium storing a computer program; the computer program, when executed by a processor, causing the processor to perform the operations of the above cloud application engine deployment method.

This method of the present invention provides a new deployment method. During the working process of the cloud service engine, the public framework script (including the script of Web framework and loaded user data) is loaded when the docker starts to execute, and then the framework script is announced, and then user script (including user code and data) is loaded and registered as a global handler. External requests received thereafter can be transmitted to the corresponding global handler to execute user code and automatically be registered as an external Web interface. This method shields the knowledge of Web framework from users, and does not require the program developers to master the professional knowledge of Web framework programming, thus reducing the implementation complexity and cost.

In addition, this application is different from the conventional idea of Docker technology. The conventional idea of Docker technology is that each operating environment is made into Docker images. However, due to the complexity of additional configuration of Web framework and the variability of Web protocol, the conventional method cannot meet the actual demand and compatibility is poor. In contrast, the embodiments described in this application doesn't put the operating environment (e.g., the version of Python in which the packages are installed) of the Python software in the image but rather puts the operating environment in the shared storage. The image can be just a bare Linux image, even without Python, and the operating environment file is downloaded to the specified location of the docker when the docker starts. The solution of the present application shields the docker knowledge from users and also solves the compatibility problem of environment migration.

### BRIEF DESCRIPTION OF DRAWINGS

In order to explain the technical solutions of the embodiments of the present application or the prior art more clearly, the following will briefly introduce the drawings that need to be used in the embodiments of the present application or the prior art. Obviously, the drawings described below are only some embodiments of the present application. For those of ordinary skill in the art, without creative work, other drawings can be obtained based on the drawings.

FIG. 1 is an example flow chart of the method provided by this present invention according to a specific embodiment.

FIG. 2 is an example schematic diagram of data processing process corresponding to embodiments herein.

FIG. 3 is an example schematic diagram of the electronic equipment corresponding to embodiments herein.

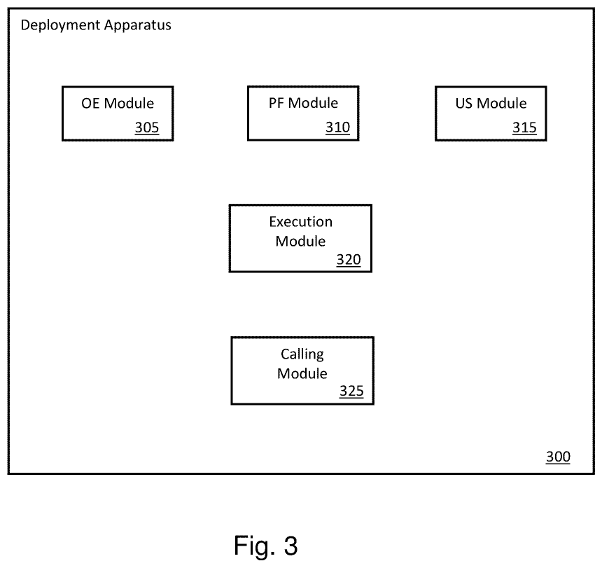

FIG. 4 is an example of a deployment apparatus for the method corresponding to embodiments herein.

### DETAILED DESCRIPTION OF EMBODIMENTS

In order to make the purpose, features, advantages of this application clearer and easier to understand, the technical solutions in the embodiments of the present invention will be clearly and completely described below with reference to the accompanying drawings in the embodiments of the present invention. Obviously, the described embodiments are only a part of the embodiments of the present invention, rather than all the embodiments. Based on the embodiments of the present invention, all other embodiments obtained by those of ordinary skill in the art without creative efforts shall fall within the protection scope of the present invention.

In view of the problems existing in the background technology of this application, this application embodiment provides a cloud application engine deployment method for shielding the Web framework from users.

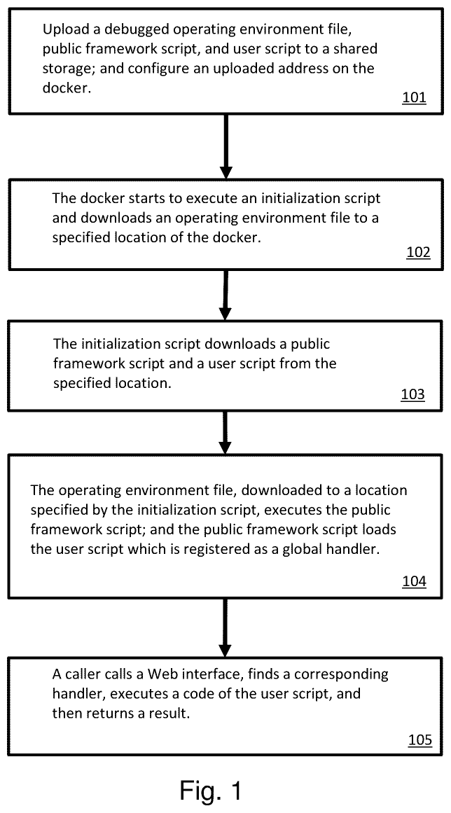

FIG. 1 is an example flow chart of a method according to a specific embodiment. As shown in FIG. 1, the flow chart includes:

Step 1) A debugged operating environment file, public framework script and user script are uploaded to a shared storage and an uploaded address on the docker is configured (101).

The program language used in embodiments herein can be Python or some other program language. In this example embodiment, Python is used. The operating environment file is a software and a resource of an application instance in the Python language. The operating environment file of the Python language comprises a base language library and an extension library. The Python language uses a Conda package management tool, and its operating environment file is a Conda subdirectory. Copying this directory can realize the migration of the environment.

The program language script can include a public script and a user script. “Public script” is generally a public script of the service layer of multiple users, while “user script” of the program language is a user's own script. The common framework script described in this embodiment consists of a script of a Web framework and loaded user data, and then the framework script is announced and then user script which includes user code and data is loaded.

In this embodiment, a debugged operating environment file, public framework script and user script are uploaded to a shared storage wherein the shared storage can be a distributed storage system, specifically a Ceph distributed storage system or other distributed storage systems. Ceph distributed storage system is a distributed file system with excellent performance, high reliability, and strong scalability, which can support cluster distributed reading.

Step 2) A docker starts to execute an initialization script and downloading an operating environment file to a specified location of the docker (102).

In this embodiment of the present application, the Docker image of the docker just is a standard Linux image without an operating environment file of Python language. The user places the local debugged environment directory as a whole in the shared storage. The startup operation of the docker first downloads the environment directory, which the user uploads to the docker, and then the docker uses the operating runtime environment to execute the aforementioned script.

The prior art idea of Docker technology is that each operating environment is made into docker images. However, the prior art method cannot meet the actual demand and compatibility is poor. It cannot solve the problems of the complexity of the additional configuration of the web framework and the variability of the web protocol.

In particular, different from the operating environment of the application instance that has been prepared in the docker images, the methods described herein don't put the operating environment (that is, the version of Python, which packages are installed) of the software Python in the image but put the operating environment in the shared storage. The image is just bare Linux, even without Python, and the operating environment file is downloaded to the specified location of the docker when the docker starts. And then the operating environment is used to execute the aforementioned script. The solution of the present application shields the Docker knowledge from users and also solves the compatibility problem of environment migration.

Step 3): the initialization script downloads a public framework script and a user script from the specified location (103).

Step 4): the operating environment file, downloaded to a location specified by the initialization script, executes the public framework script, and the public framework script loads the user script which is then registered as a global handler (104).

Here, the public framework script in this embodiment comprises a script which contains a Web framework and loaded user data, then the framework script is announced, and then user script which includes user code and data is loaded.

It can be understood that the public framework script in this specific embodiment may be, for example, Tornado service, Flask service or Django service, all of which are existing services that support network request invocation.

The global handler refers to a function in the user script. Once registered as a global handler, the function can be located by a unique name, so that the function can be called.

Step 5): a caller calls a Web interface, and finds a corresponding handler and executes a code of the user script, and returns a result (105).

The external requests received thereafter can be transmitted to the corresponding global handler to execute user code and automatically to be registered as an external Web interface.

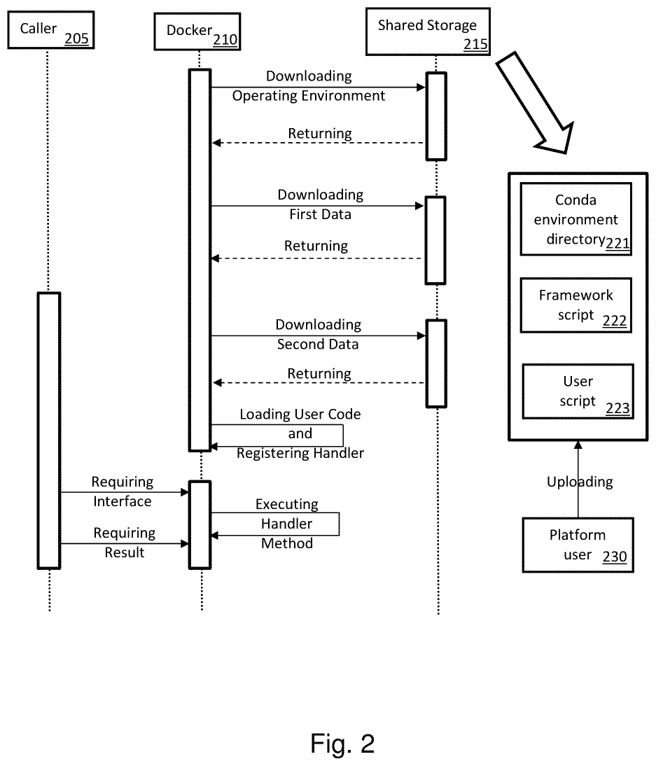

FIG. 2 is a schematic diagram of data processing process corresponding to an application embodiment provided by this present invention, including a docker (210) and a shared storage (215). The shared storage is used to upload by a platform user (230) a Conda environment directory (221), a framework script (222), and a user script (223). The Conda environment directory is the operating environment file of Python language. Copying this directory can realize the migration of the environment. The framework script is a public frame script, and comprises a Web frame and loaded user data. The user script comprises user code and data.

After the docker starts, first the initialization script is executed, a request for downloading the operating environment is sent to the shared storage, the shared storage returns information, and the docker downloads the operating environment from the specified address in the docker to the specified location. The operating environment file is a software and resource of an application instance in the Python language. The operating environment file of the Python language comprises a base language library and an extension library. The Python language uses a Conda package management tool, and its operating environment file is a Conda subdirectory. Copying this directory can realize the migration of the environment.

Then, the initialization script sends a request for downloading a first data, the shared storage return the information, and the public framework script is downloaded to the specified location of the docker. The initialization script sends a request to download a second data, and the shared storage returns the information, and the public framework script is downloaded to the specified location of the docker. Next, the operating environment file downloaded to local which is specified by the initialization script executes the public framework script, and the public framework script loads the user script which is registered as a global handler.

The caller (205) calls the Web interface, finds the corresponding handler, executes the code of the user script, and returns the result from the code of the user script.

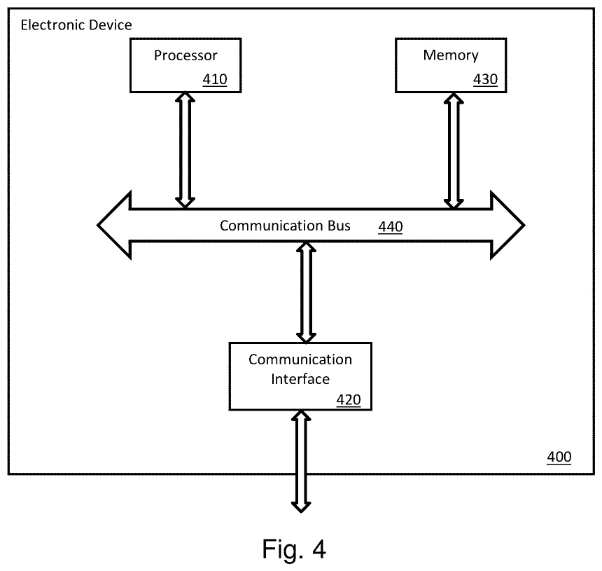

The above is a detailed description of an embodiment of a cloud application engine deployment method for shielding a web framework from users provided by this application. The following is a detailed description of an embodiment of a cloud application engine deployment apparatus for shielding a web framework for users provided in this application and shown in FIG. 4. It should be noted that, the cloud application engine deployment apparatus for shielding a web framework for users described below and the cloud application engine deployment method for shielding web frameworks for users described above may refer to each other correspondingly.

The above deployment apparatus (300) comprises: an OE (operating environment) module (305) for downloading an operating environment file, the OE module configured for a docker to execute an initialization script and download an operating environment file to a specified location of the docker; a PF (public framework) module (310) for downloading a public framework script, the PF module configured for the initialization script to download a public framework script from the specified location; a US (user script) module (315) for downloading a user script, the US module configured for the initialization script to download a user script from the specified location; an execution module (320), configured for the operating environment file downloaded to local which is specified by the initialization script to execute the public framework script and for the public framework script to load the user script and then to be registered as a global handler; a calling module (325), configured for a caller to call a Web interface, and to find a corresponding handler and execute a code of the user script, and return a result from the code of the user script.

FIG. 4 is a schematic diagram of the electronic equipment corresponding to the application embodiment provided by this present invention. As shown in FIG. 4, the present invention also provides an electronic device, comprising a processor (410) and a communication interface (420), a memory (430) and a communication bus (440), wherein the processor (410), the communication interface (420) and the memory (430) may communicate with each other via the bus (440). The computer program in the memory (430), when executed by the processor (410), causing the processor to perform the operations of the cloud application engine deployment method, as follows: executing, by a docker, an initialization script and downloading, by the docker, an operating environment file to a first location; downloading, by the initialization script, a public framework script and a user script from the first location; specifying, by the initialization script, a second location; downloading the operating environment file to the second location; executing, by the operating environment file, the public framework script; loading, by the public framework script, the user script; registering the user script as a global handler; calling, by a caller, a Web interface; finding, by the caller, a corresponding handler; executing, by the caller, a code of the user script; and returning, from the caller, a result from the code of the user script.

In addition, the logic instructions in the memory (330) may be implemented in the form of a software function unit and, when sold or used as an independent product, may be stored in a computer-readable storage medium. Based on the above understanding, the technical solution of the present invention can be embodied in the form of a software product in essence, or the part that contributes to the prior art, or the part of the technical solution. The computer software product is stored in a storage medium, including several instructions used to cause a computer device (which may be a personal computer, a server, or a network device, etc.) to execute all or part of the steps of the methods of various embodiments of the present invention. The aforementioned storage medium includes: U disk, mobile hard disk, ROM (Read-Only Memory), RAM (Random Access Memory), magnetic disk or optical disk and other media that can store program codes.

On the other hand, an embodiment of the present application further provides a computer-readable storage medium, the computer-readable storage medium storing a computer program, the computer program, when executed by a processor, causing the processor to perform the operations of the cloud application engine deployment method, as follows: executing, by a docker, an initialization script and downloading, by the docker, an operating environment file to a first location; downloading, by the initialization script, a public framework script and a user script from the first location; specifying, by the initialization script, a second location; downloading the operating environment file to the second location; executing, by the operating environment file, the public framework script; loading, by the public framework script, the user script; registering the user script as a global handler; calling, by a caller, a Web interface; finding, by the caller, a corresponding handler; executing, by the caller, a code of the user script; and returning, from the caller, a result from the code of the user script.

The computer-readable storage medium can be any available medium or data storage device that can be accessed by a computer, including but not limited to, magnetic storage (such as floppy disk, hard disk, magnetic tape, magneto-optical disk (MO), etc.), optical storage (such as CD, DVD, BD, HVD, etc.), and semiconductor memory (such as ROM, EPROM, EEPROM, non-volatile memory (NAND FLASH), solid state disk (SSD)), and the like.

The apparatus embodiment described above are only illustrative, wherein the units described as separate components may or may not be physically separated, and the components shown as units may or may not be physical units which may be located in one place, or it can be distributed over multiple network elements.

Some or all of the modules may be selected according to actual needs to achieve the purpose of the solution in this embodiment. Those of ordinary skill in the art can understand and implement it without creative effort.

Through the description of the above implementation, those skilled in the art can clearly understand that each embodiment can be implemented by means of software plus a requisite general hardware platform, and certainly can also be implemented by hardware. Based on this understanding, the above-mentioned technical solution of the present invention can be embodied in the form of a software product in essence, or the part that contributes to the prior art or the part of the technical solution. The computer software product is stored in a storage medium, such as ROM/RAM, magnetic disc, optical disc, etc., including several instructions used to cause a computer device (which may be a personal computer, a server, or a network device, etc.) to execute all or part of the steps of the methods of various embodiments of the present invention.

Finally, it should be noted that the above embodiments are only used to illustrate the technical solutions of the present invention, and is not intended to be limiting of the present invention. Although the present invention has been described in detail with reference to the foregoing embodiments, those of ordinary skill in the art should understand that various changes and modifications may be made by those skilled in the art. Any modifications, equivalent substitutions, improvements, and the like within the spirit and principles of the application are intended to be included within the scope of the present application.

1. A cloud application engine deployment method for shielding a Web framework from users, comprising:
executing, by a docker, an initialization script and downloading, by the docker, an operating environment file to a first location;
downloading, by the initialization script, a public framework script and a user script from the first location;
specifying, by the initialization script, a second location;
downloading the operating environment file to the second location;
executing, by the operating environment file, the public framework script;
loading, by the public framework script, the user script;
registering the user script as a global handler;
calling, by a caller, a Web interface;
finding, by the caller, a corresponding handler;
executing, by the caller, a code of the user script; and
returning, from the caller, a result from the code of the user script.

2. The cloud application engine deployment method according to claim 1, wherein, the operating environment file is a software and a resource of an application instance in Python language; the operating environment file of the Python language comprising a base language library and an extension library.

3. The cloud application engine deployment method according to claim 2, wherein, the Python language uses a package management tool, and its operating environment file is a subdirectory of the package management tool.

4. The cloud application engine deployment method according to claim 1, wherein, the public framework script comprises a script which contains Web framework and loaded user data, and the user script comprises user code and user data.

5. The cloud application engine deployment method according to claim 1, wherein, before the docker starts to execute an initialization script, a debugged operating environment file, public framework script and user script are uploaded to a shared storage and an uploaded address on the docker is configured.

6. The cloud application engine deployment method according to claim 5, wherein, before the docker starts to execute an initialization script, a docker image of the docker is a standard Linux image without an operating environment file of Python language.

7. The cloud application engine deployment method according to claim 5, wherein, the shared storage is a distributed storage system.

8. A cloud application engine deployment apparatus that shields the Web framework from users, comprising:
a module for downloading an operating environment file, configured for a docker to execute an initialization script and download an operating environment file to a specified location of the docker;
a module for downloading a public framework script, configured for the initialization script to download a public framework script from the specified location;
a module for downloading a user script, configured for the initialization script to download a user script from the specified location;
an execution module, configured for the operating environment file downloaded to local which is specified by the initialization script to execute the public framework script and for the public framework script to load the user script and then to be registered as a global handler;
a calling module, configured for a caller to call a Web interface, and to find a corresponding handler and execute a code of the user script, and return a result from the code of the user script.

9. An electronic device, comprising a processor and a memory storing a computer program, the computer program, when executed by the processor, causing the processor to perform the operations of the cloud application engine deployment method according to claim 1.

10. A computer-readable storage medium, the computer-readable storage medium storing a computer program, the computer program, when executed by a processor, causing the processor to perform the operations of the cloud application engine deployment method according to claim 1.
